(19) United States
(12) Patent Application Publication
(10) Pub. No.: US 2023/0077428 A1
(43) Pub. Date: Mar. 16, 2023

(54) PREDICTIVE RECOVERY AND PERFORMANCE ANALYSIS SYSTEMS AND METHODS

(71) Applicant: Proven Performance Technology, Inc., Chicago, IL (US)

(72) Inventors: Matthew PROVENCHER, Vail, CO (US); Tyler ZAJAC, Avon, CO (US); Sriram IYENGAR, Chennai (IN); Mark COTE, Windsor, CT (US); Joseph ROSSETTIE, San Diego, CA (US); Dane DROTTS, Chicago, IL (US); Jean Pierre VALENCIA GOMEZ, Chicago, IL (US)

(21) Appl. No.: 17/672,009

(22) Filed: Feb. 15, 2022

(30) Foreign Application Priority Data
Aug. 19, 2021 (IN) 202124037564

(51) Int. Cl. G06F 16/953; G06F 16/951; G06Q 50/00

(52) U.S. Cl. CPC G06F 16/953; G06F 16/951; G06Q 50/01

(57) ABSTRACT

Systems and methods herein provide for predicting a player's performance in a particular sport. For example, in fantasy football, users may form teams by selecting players based on player statistics. The embodiments herein may employ machine learning by training and machine learning module with various statistics of individual players (e.g., according to position) so as to predict the performance of individual players.

### CROSS REFERENCE TO RELATED APPLICATIONS

This patent application is a non-provisional patent application claiming priority to, and thus the benefit of an earlier filing date from, Indian Patent Application No. 202124037564 (filed Aug. 19, 2021), which claims priority to U.S. Provisional Patent Application No. 63/067,579 (filed Aug. 19, 2020), the entire contents of each of which are hereby incorporated by reference.

### FIELD

Embodiments of the present disclosure generally relate to predictive recovery and performance analysis and, more particularly, to systems, methods, and devices for predictive recovery and performance analysis.

### BACKGROUND

Anecdotal analysis is used to predict recovery and post-recovery performance. Such analysis is insufficient to effectively predict recovery and future performance. For example, related art systems commonly group all injuries together without the ability to differentiate between detectable severity or individual resilience. While, on average, the related art may provide a reasonable predictor, it is unable to regularly provide accurate recovery assessments in individual cases. Accordingly, aspects of the present disclosure provide alternative systems, methods, and devices that attempt to address certain these and other issues in the related art approaches.

### BRIEF DESCRIPTION OF THE DRAWINGS

The accompanying drawings, which are incorporated in and constitute a part of this specification, illustrate multiple embodiments of the presently disclosed subject matter and serve to explain the principles of the presently disclosed subject matter. The drawings are not intended to limit the scope of the presently disclosed subject matter in any manner.

FIG. 1 is an example environment for implementing aspects of the present disclosure.

FIG. 2 is a flow diagram illustrating predictive recovery and performance analysis according to aspects of the present disclosure.

FIG. 3 is a depiction of a menu screen according to according to aspects of the present disclosure.

FIGS. 4A-4D illustrate live injury tracker interfaces according to aspects of the present disclosure.

FIG. 5 illustrates a player dashboard according to aspects of the present disclosure.

FIG. 6 illustrates a player injury interface according to aspects of the present disclosure.

FIG. 7 illustrates a player performance interface according to aspects of the present disclosure.

FIG. 8 illustrates a player comparison interface according to aspects of the present disclosure.

FIG. 9 illustrates a weather interface according to aspects of the present disclosure.

FIGS. 10 and 11 illustrate a comparison interface according to aspects of the present disclosure.

FIG. 12 is a flowchart of a method according to aspects of the present disclosure.

FIG. 13 illustrates a data flow according to aspects of the present disclosure.

FIGS. 14-16 are application flow diagrams according to aspects of the present disclosure.

FIG. 17 is a block diagram of an illustrative computer system architecture according to aspects of the present disclosure.

FIG. 18 is a block diagram of a computing system operable to implement a machine learning model, in one exemplary embodiment.

### DETAILED DESCRIPTION

Although certain embodiments of the disclosure are explained in detail, it is to be understood that other embodiments are contemplated. Accordingly, it is not intended that the disclosure is limited in its scope to the details of construction and arrangement of components set forth in the following description or illustrated in the drawings. Other embodiments of the disclosure are capable of being practiced or carried out in various ways. Also, in describing the embodiments, specific terminology will be resorted to for the sake of clarity. It is intended that each term contemplates its broadest meaning as understood by those skilled in the art and includes all technical equivalents which operate in a similar manner to accomplish a similar purpose.

To facilitate an understanding of the principles and features of the disclosure, various illustrative embodiments are explained below. The present disclosure, however, is not so limited, and can be applicable in other contexts.

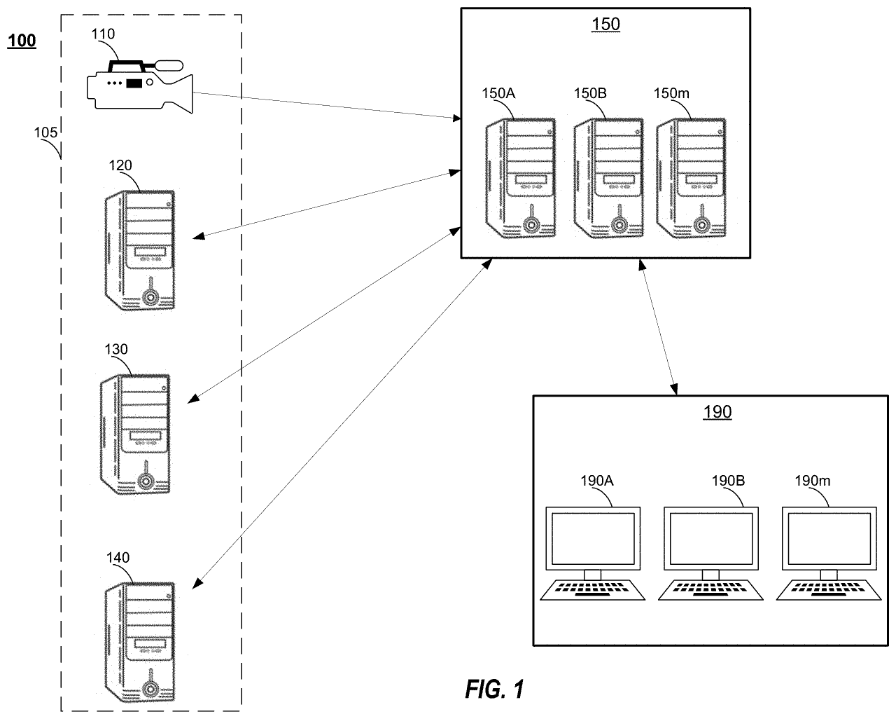

FIG. 1 illustrates a system environment 100 in which aspects of the present disclosure may be implemented. Referring to FIG. 1, environment 100 may include one or more system device 150 (e.g., servers 150A, 150B, 150m) in communication with one or more of cameras 110, team databases 120, historical databases 130, and social media databases 140 (collectively or individually, “sources” 105), for example, over a network. System device 150 may capture visual data (e.g., video and images), textual data (e.g., reports and announcements, and/or circumstantial data (e.g., location data based on social media) from the sources 105. One of ordinary skill in light of the present disclosure will recognize that, in some cases, not all of the sources 105 depicted in FIG. 1 will be included within a system environment 100 and that additional or alternative sources 105 may be utilized by system device 150.

Camera 110 may capture video or film footage. For example, camera 110 can be a sports camera capturing one or more angles of a football game. Video from camera 110 may be analyzed by system device 150 to determine a severity of an impairment and predictive recovery thereof. In some cases, system device 150 can utilize live video from camera 110 to perform real-time injury analysis as it occurs. For example, system devices 150 may transform the video into a stick figure overlay and process the overlay to determine, for example, impact angles and severity. The video analysis may utilize player-specific data (e.g., height, weight from team databases 120) for injury analysis. System 150 may analyze the video to classify the injury. In some cases, the captured image data may be biographical video of a player's daily interactions. Although injuries are generally discussed to be physical injuries, this is merely an example and one of ordinary skill will recognize that aspects of the present disclosure may be applied beyond physical injuries and including performance prediction following or during illness and/or following a prolonged leave of absence (e.g., involuntary suspension or a voluntary opt-out).

Team database 120 and historical databases 140 may be third-party systems that maintain player information. For example, team database 120 may include current player data, injury reports and assessments, and team-maintained statistics. Similarly, historical database 140 may maintain historical information about various players including, for example, player statistics before and after previous injuries, player ratings and statistics in earlier seasons, and player statistics and ratings in earlier leagues. System devices 150 may subscribe to team database 120 and historical database 130 and receive updates from team and historical databases as they are updated.

Social media database 140 may serve as one or more repositories of user social media data. For example, a player may post a message on associated social media accounts discussing their injury, prognosis, attitude, and/or behavior to social media. System devices 150 may access the social media databases and scrape data therefrom. This user-generated content can be utilized in injury analysis. For example, system device 150 may perform natural language processing on the social media data to determine injury-relevant information. In some cases, system devices 150 may independently identify social media accounts associated with various individuals. For example social media accounts may be identified based on one or more of links provided on player websites hosted by specific teams, the use of specialized (e.g., verified) accounts, and/or natural language analysis of various twitter feeds.

System devices 150 can analyze the data to generate data clusters for each player, game, weather type, stadium, and turf type. Alternatively or additionally, clusters can include injury modeling and data (e.g., as derived in part from analysis of the video) and historical data such as historical performance in prior leagues and combine results. In some cases, the system devices 150 identify dependent variables that affect performance using a multivariate approach that identifies the most significant factors for particular players. This player data with identified factors are then placed in clusters and are allowed to interact with other situational data and player clusters to determine overall performance predictions. As will be understood by one of ordinary skill, most machine learning algorithms require data to be independent and identically distributed, often referred to as “IID.” To use such machine learning algorithms, multivariate data must be condensed to meet the IID requirements, which results in the elimination of detail. Clustering the data allows for a multivariate assessment that can model the impact of multiple independent and dependent variables (such as past injury, opposing defensive strength, weather conditions, etc.) on production while accounting for dependent/correlated data.

User devices 190 may access system devices 150 to request specific analysis and responses. For example, user devices 190 may query system devices 150 regarding player injury and recovery status. However, this is merely an example. For instance, alternatively or in addition, user device 190 may query player performance based on weather or stadium type. System devices 150 may receive the query, perform biostatistics on the data received from sources 105, and analyze a subset of the data determined based on the biostatistics approach to address the query from user devices 190. System devices 150 may be flexible to respond to various queries that can be based on specific types of data (e.g., weather, location, stadium type, etc.), along with customized comparisons based on upcoming potential opponents.

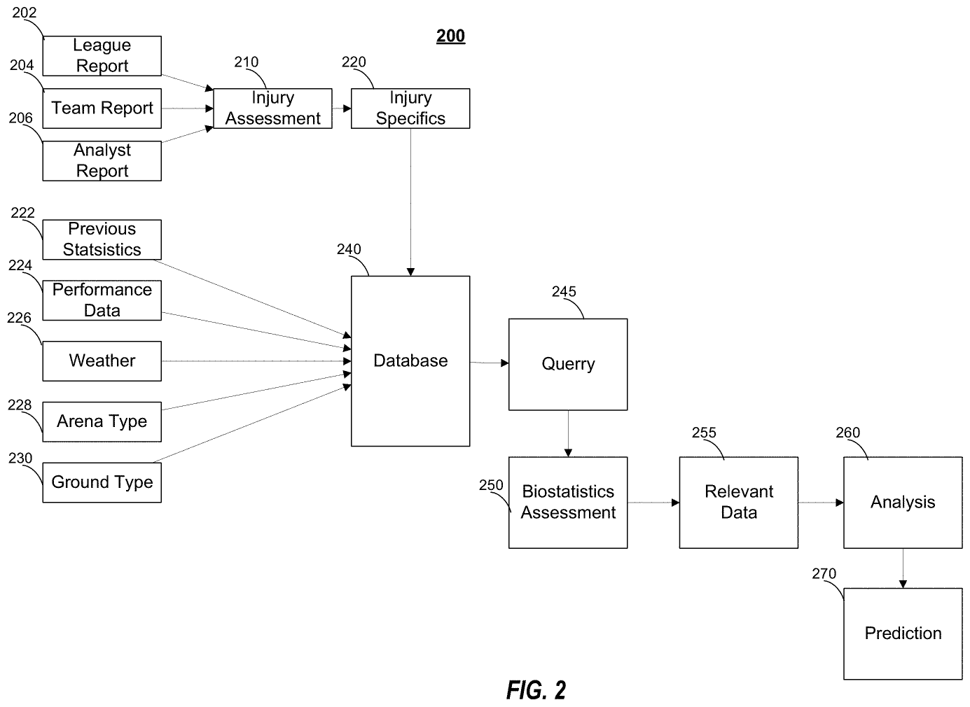

FIG. 2 is a flow diagram 200 illustrating predictive recovery and performance analysis according to aspects of the present disclosure. The flow diagram 200 illustrates, for example, operation of system devices 150. System devices 150 receive a league report (e.g., a league injury report) a team report (e.g., a team injury report), and/or analyst reports (206). Additionally, as discussed, system devices 150 may receive live or recorded video and images (110). Based on this information, system devices 150 perform an injury assessment (210) and transform that data into injury specific data (220) that are stored in database 240. Database 240 may likewise store previous statistics 222, performance data 224, weather data 226, arena type 228 (e.g., open or dome), ground type 230 (e.g., grass or turf), etc.

When system devices 150 receive a query 245 (e.g., from user devices 190), system devices 150 may perform a biostatistics assessment 250 on the data in database 240. The biostatistics assessment identifies the relevant data 255 within database 140 for the specific query 245. The relevant data 255 is then analyzed with a trained machine-learning algorithm (260) to respond to the query and make intelligible predictions (270). The system devices 150 can use a multilevel approach to model the data. As discussed above, unlike in most related art machine-learning algorithms that require independent and identically distributed data, this approach allows the data to be dependent meaning. For example, while a player's data may be compressed into a single “row” of data, the present system can include all individual rows of a player's game data, along with all other comparative players and their respective games and seasons. Using this multilevel model, regression equations for each level or cluster of data can be created. Separate multilevel models may be generated for each type of player (e.g., position), while players can be individually assessed by game and/or season using a nesting approach that allows each player's intercept and slope (e.g., performance and/or predicted performance) to be determined. Clusters can be based on, for example, teams, positions, and class years. As a result, the system devices 150 can utilize a multivariate model that provides predicted performance based on, for example, coefficients for injury and situation data (how much performance is expected to change with a given injury or defensive, etc.) while also clustering specific parameters that specify how each player is impacted by these variables, as they have their own cluster(s). All clusters can be analyzed individually, against each other, and versus all types of other clusters to determine unique parameters of performance.

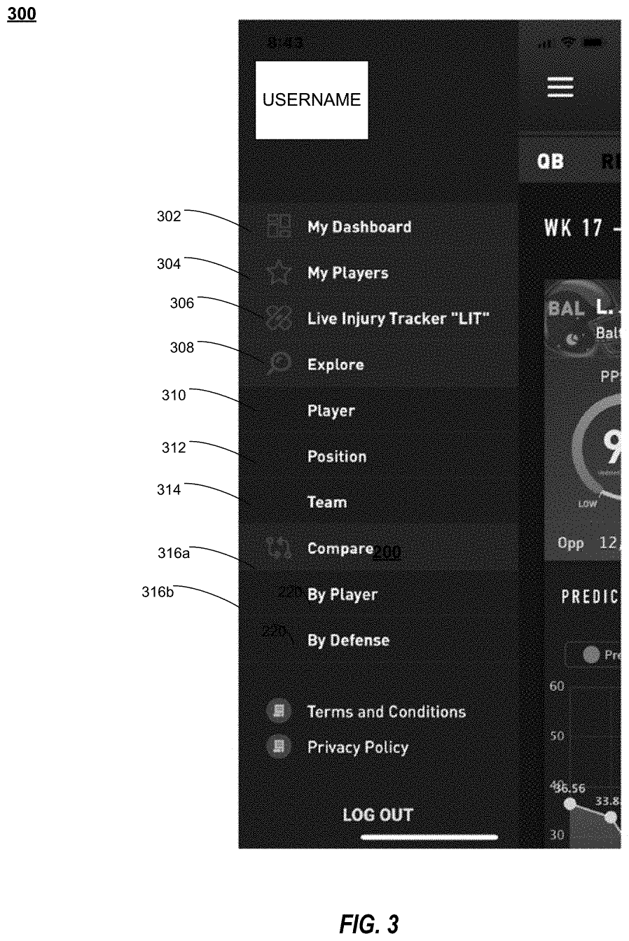

FIG. 3 is a depiction of a menu screen 300 according to according to aspects of the present disclosure. Menu 300 includes selectable options for a main dashboard 302, selected players 304 (e.g., players on a favorite team or on one or more fantasy teams), a Live Injury Tracker 306, explore 308, player screen 310, position screen 312, team screen 314, and a compare screen 316. These are merely example and one of ordinary skill would recognize that fewer, additional, and/or alternative options may be available in menu screen 300.

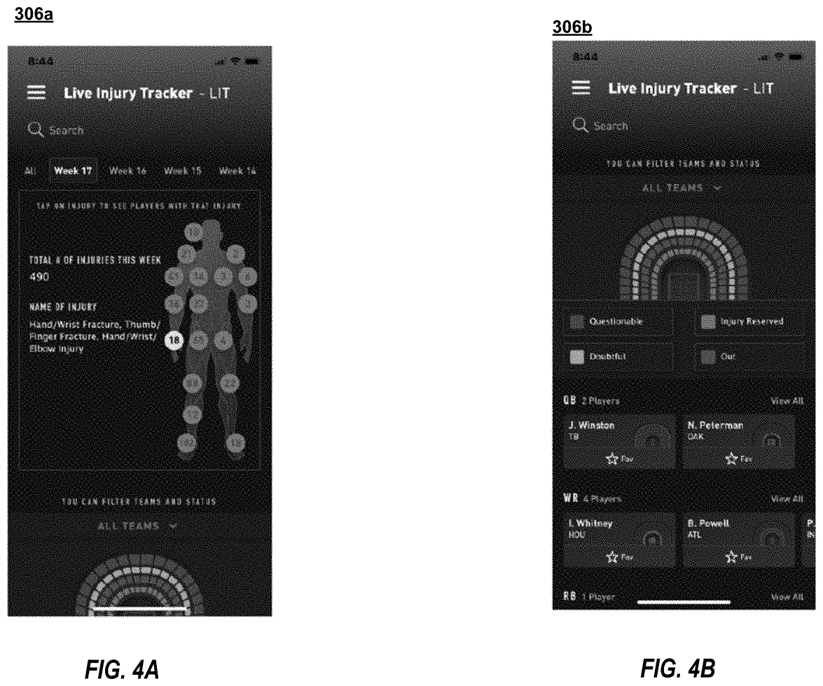

FIGS. 4A-4D illustrate aspects of live injury tracker interfaces 306 according to aspects of the present disclosure. In FIG. 4A, a user interface 306a provides an outline of a body with injury icons depicted adjacent thereto. The injury icons are selectable by a user and can, for example, provide additional information regarding the respective injury. For instance, in FIG. 4A, a general injury tracker 306a provides summaries of injuries observed throughout the league. As pictured, the injury icons include a number of such injuries detected over a given time period (e.g., a number of injuries in a given week). Selecting a specific injury icon will display players having an injury at the associated location.

In FIG. 4B, a user interface 306b provides an overview of players having a specific injury. As shown, 306b organizes provides an interface sorting players based on return status (e.g., questionable, doubtful, injury reserved, and out). The players can organized by position. In some cases, players having the injury can be filtered based on a selected team. FIG. 4C illustrates a user interface 306c listed players filtered based on injury location (e.g., right hand) and position (e.g., quarterback). However, this is merely an example. FIG. 4D illustrates a full listing of injured players. As shown, the list is alphabetized by player name.

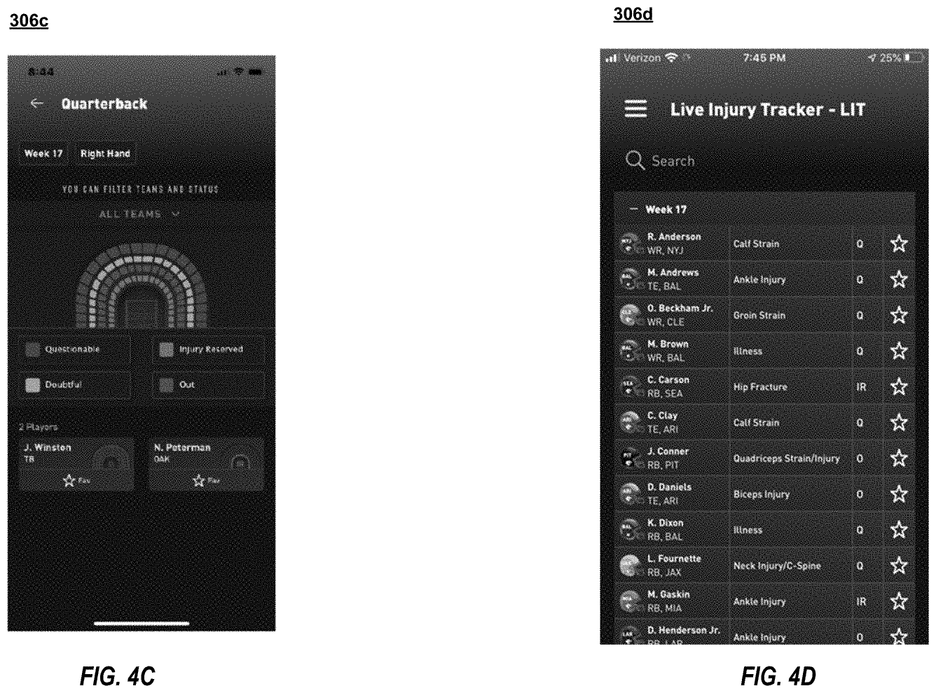

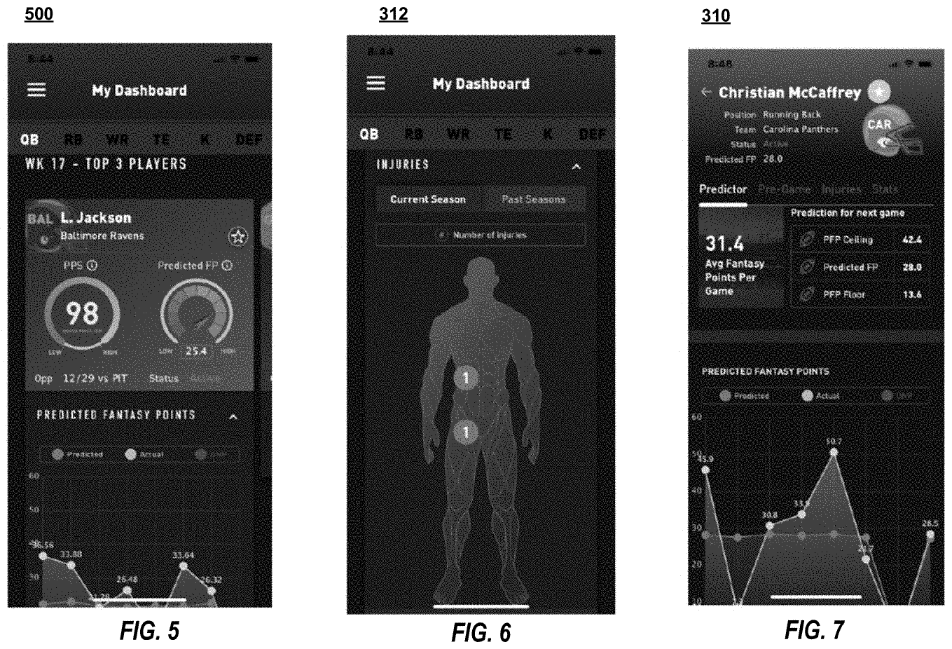

FIG. 5 illustrates a player dashboard 500 according to aspects of the present disclosure. In FIG. 5, a user has selected the quarterback position. As a default, dashboard 500 may provide the top three players at the selected position. Top players can be determined based on, for example, recent success and/or predicted ongoing value. Dashboard 500 may be a default interface for the application. When one of the players is selected, interface 312 of FIG. 6 may be presented. Interface 312 may include an outline of a body with injury icons depicted adjacent thereto at injury locations of the selected player. The injury icons may include a numerical value, for example, indicating a severity of the identified injury, a recurrence of the injury, and/or a number of injuries in a specific location.

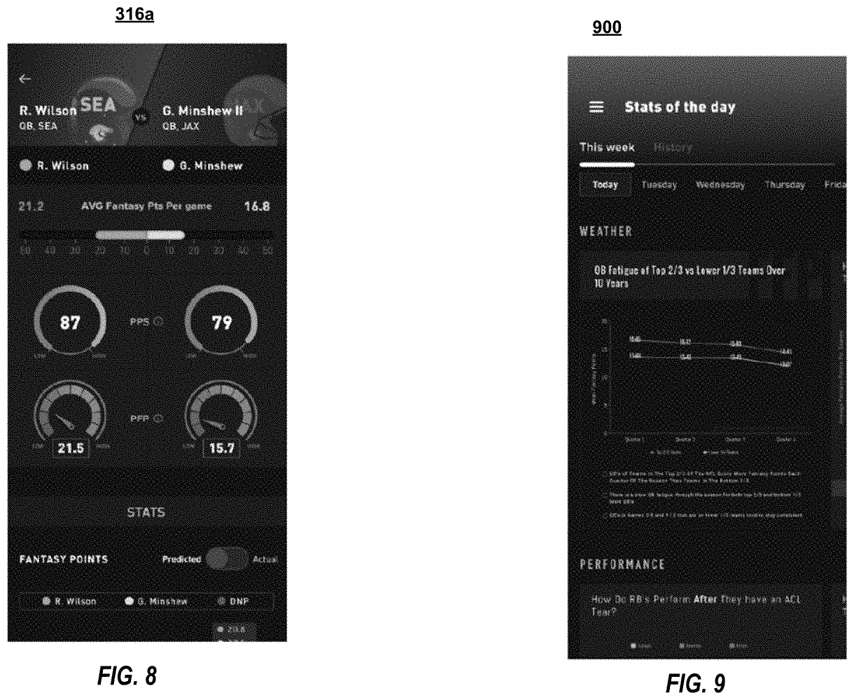

FIG. 7 illustrates a player performance interface 310 according to aspects of the present disclosure. Interface 310 may include expected points (e.g., predicted FP), range of possible points (e.g., PFP ceiling and floor), and past predicted and actual point values. The player performance interface 310 can include user interface options for adjusting characteristics for recovery prediction. In some cases, the user interface options could include slide bars (e.g., adjustable sliders) for adjusting characteristics of the situation to explore potential ceilings and floors (e.g., a range of predictive performance) based on differing circumstances.

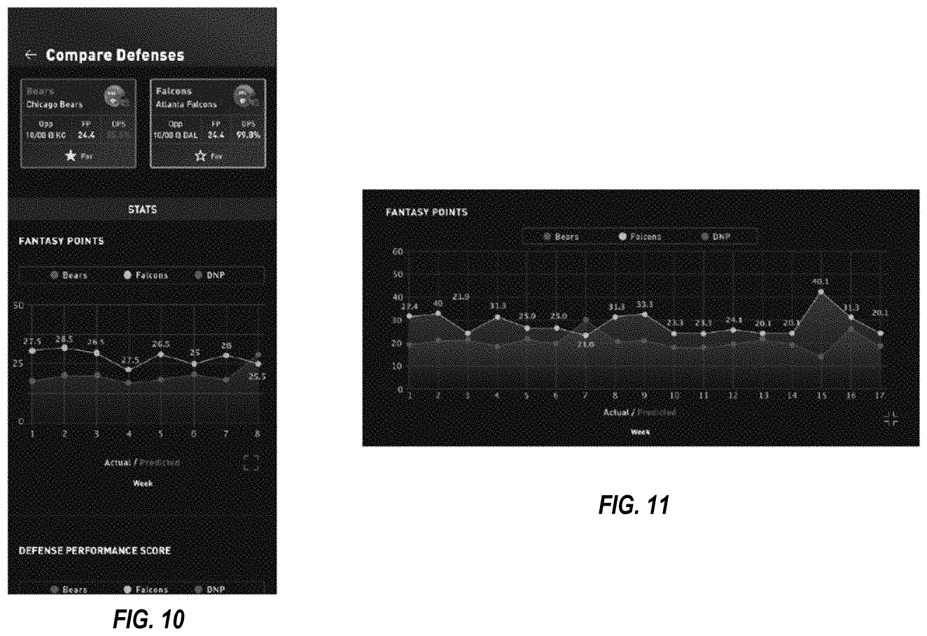

FIG. 8 illustrates a player comparison interface 316a according to aspects of the present disclosure. Interface 316a may include a number line depicting average points per game, performance score and future predictions. The interface 316a may also include circular graphs depicting, for example, performance score (PPS), and/or predicted points (PFP). In some cases, interface 316a may include a switch to toggle between predicted and actual values.

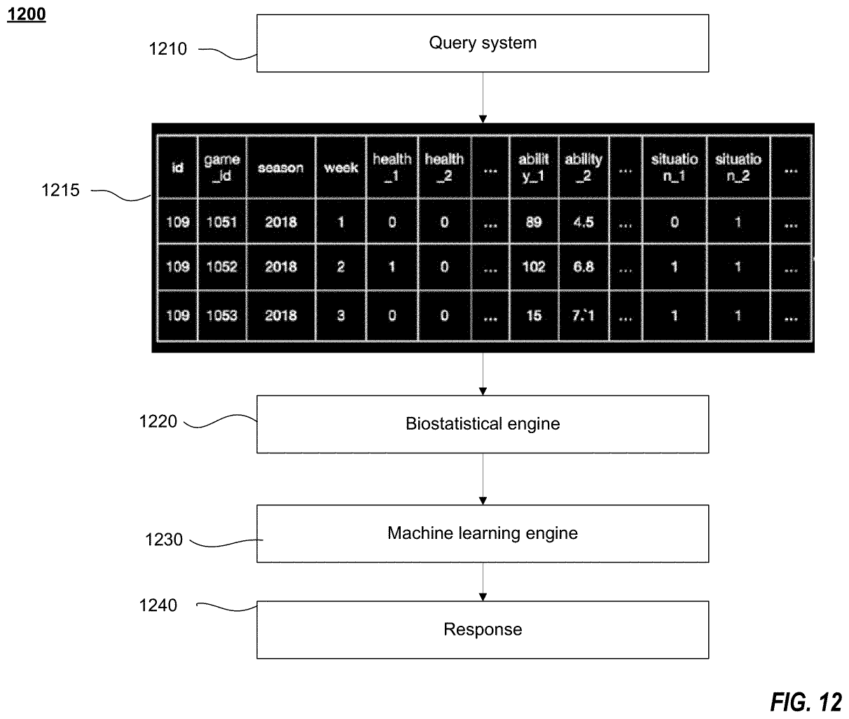

FIG. 9 illustrates a weather interface 900 according to aspects of the present disclosure. The weather interface 900 may include predictive analysis based on the precited weather and other contemporary information. For example, interface 900 can include information on player fatigue based on predicted weather. In some cases, interface 900 may include links to specific injury recovery and performance prediction.

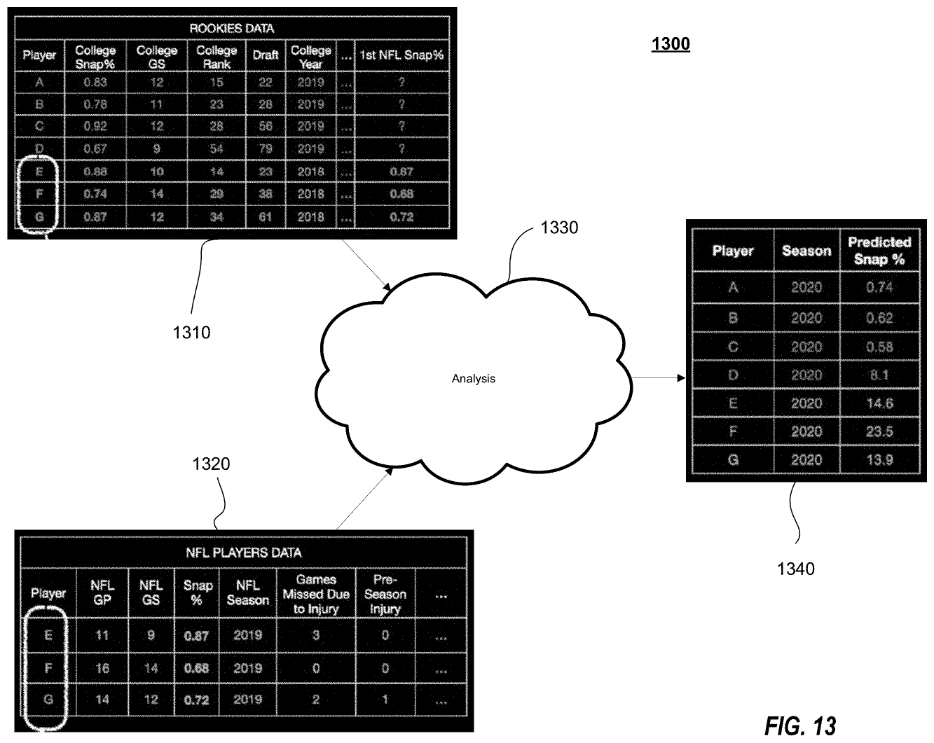

FIGS. 10 and 11 illustrate a team defense comparison interface 316b according to aspects of the present disclosure. Interface 16a may include a number line depicting average points per game, performance score and future predictions. The interface 316b may also include statistics about the respective teams, as well as a graphical interface depicting a comparison between predictive (or actual) point values

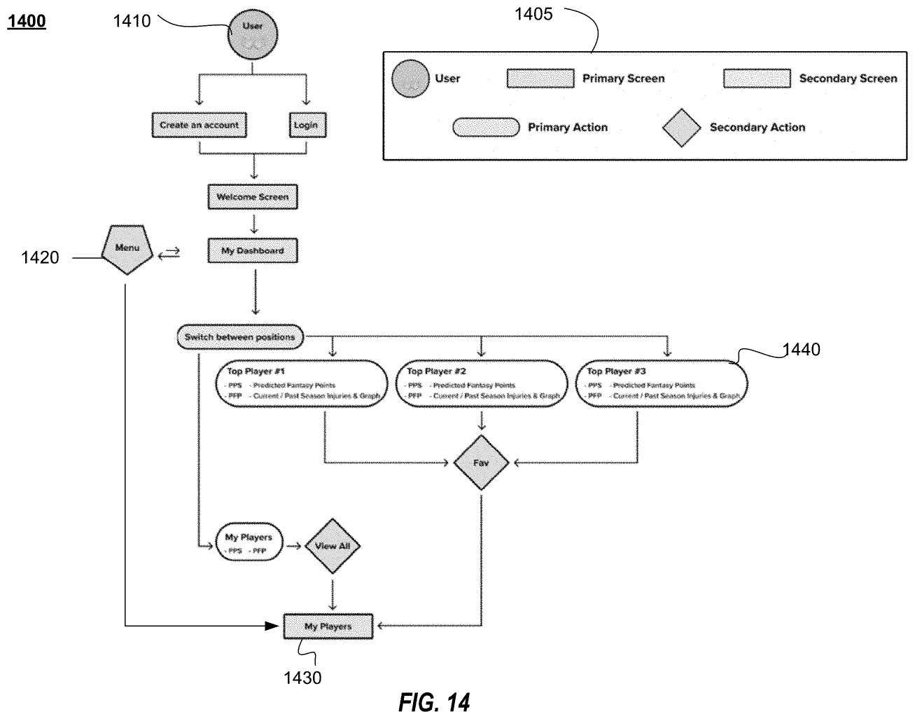

FIG. 12 is a flowchart of a method 1200 according to aspects of the present disclosure. The method 1200 may be performed, for example, by system devices 150. System device 150 receives 1210 a query. The query can request information on specific players, positions, teams, and/or injury reports, as non-limiting examples. In response, a biostatistical engine is applied 1220 to the database 1215. The biostatistical engine is provided to analyze the data in database 1215 and selectively identify relevant data for further analysis based on the query. Database 1215 can include a variety of data categories that have been transformed from the original source of the data. For example, database 125 can include be grouped by player (id) and by game (game_id), with each identifying time (season, week), health status (e.g., health_1), results (e.g., ability_1), and various situational identities (e.g., situation_1). This data can be cardinal (e.g., id, game_id, season, week), binary (e.g., health_1, situation_1), and/or decimal (e.g., ability_1).

Biostatistical engine analyzes the database in light of the query and selects specific cells for further analysis. Biostatistical engine can then send these selected cells to the machine learning engine. For example, biostatistical engine can send address information of the selected cells to machine learning engine. However, this is merely an example. In some cases, biostatistical engine can further transform the database 1215 data by extract or copying the relevant cells into a custom data structure based on the query. The machine learning engine processes 1230 the selected data to answer the query.

System devices 150 then output 1240 a response to the query. Outputting 1240 the response can include generating a custom graphical representation of the results of the query. For example, if the query was a comparison of two players, system device 150 could generate a plurality of graphs depicting the results of the comparison (e.g., as depicted in FIG. 8). In some cases, the query can be an injury report, and system device 150 can generate a body overlay depicting locations of injuries (e.g., as depicted in FIGS. 4A and 6). In some cases, system device 150 can identify a player who is unlikely to provide previously predicted value (e.g., based on a newly identified injury, updates to an injury report, or new video or social media information). If the differences between previous and current predicted results exceeds a threshold, system device 150 automatically exchanges the player for an alternative player at a same or similar position having a greater predicted value. In some cases, the threshold may be a preset point value. Additionally or alternatively, the threshold may be may on a highest available predicted performance (e.g., anything less than 80% of a highest predicted performance for an available alternative player). Additionally or alternatively, the threshold may be based on a change from previous selection (e.g., a drop of more than 25% of an initial predicted performance). In some cases, system device 150 can automatically assign players and/or groups of players (e.g., teams) to particular clusters or adjust cluster assignment to identify, for example, players that have higher predicted performance in certain circumstances (e.g., field types, weather conditions, after certain injuries, early vs. late season, playoffs). System 150 may provide various types of data associations (e.g., plots such as forest plots or cluster plots) to interpret and provide associations among complex data points.

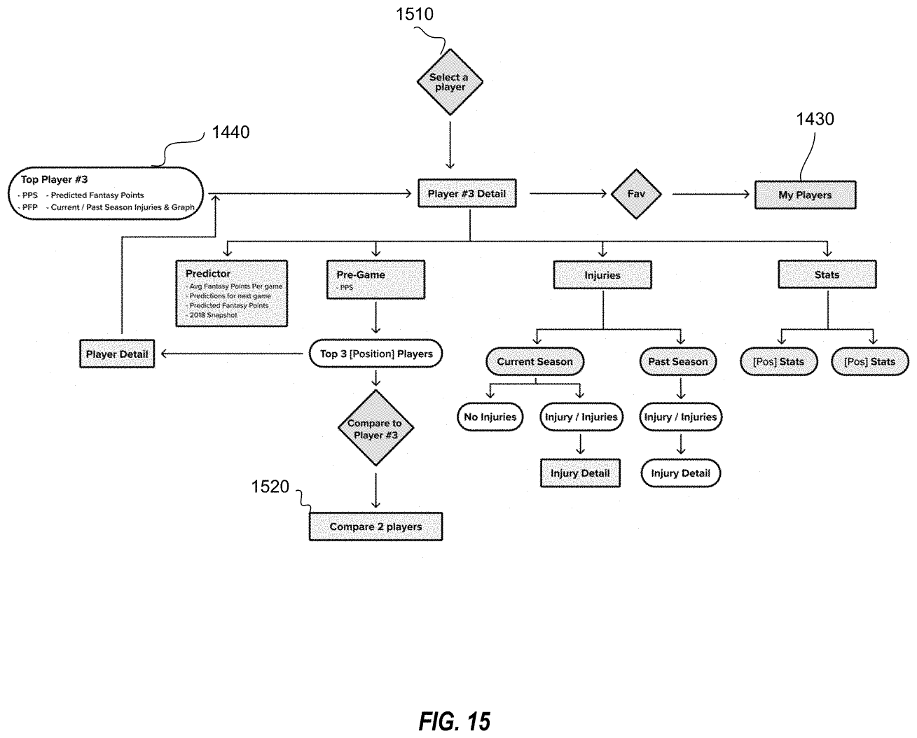

FIG. 13 illustrates a data flow 1300 according to aspects of the present disclosure. FIG. 13 illustrates a response to a query regarding predicted snap utilization. The data flow 1300 can be performed by system devices 150. System devices 150 can utilize both data from historical databases 1310 (e.g., college statistics) and data from current databases 1320 (e.g., career statistics) for a same player. These separate data structures can be separately segmented and processed through different models in parallel (1330). Each model can be designed to resolve the various data structures applied thereto. For players with information in both data sources, the results of the multiple models can be combined into a single result depicting predicted snap percentages 1340 in a future season.

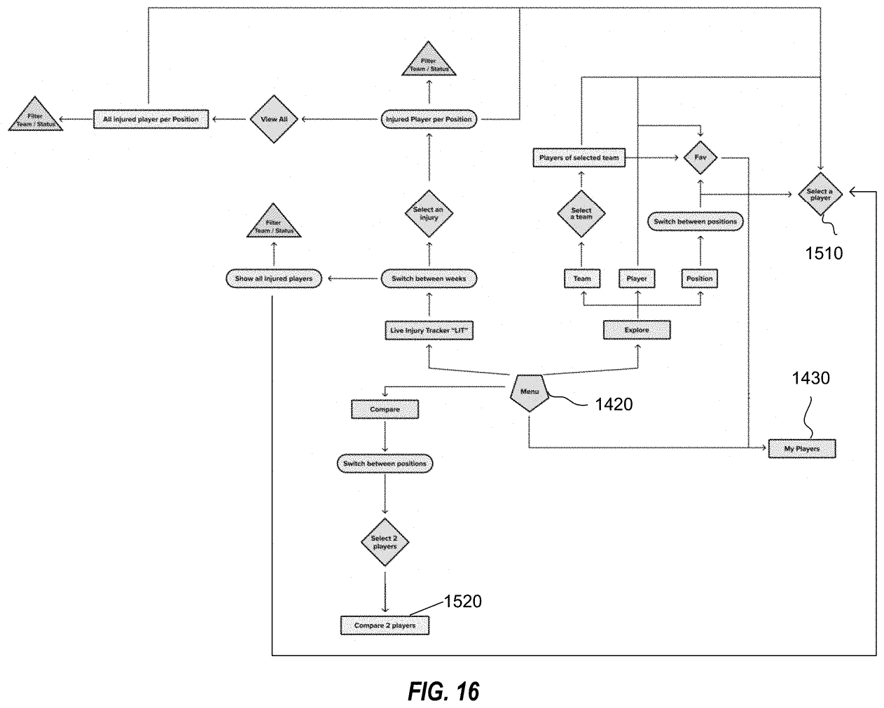

FIGS. 14-16 are overlapping application flow diagrams 1400, 1500, 1600 according to aspects of the present disclosure. Overlapping portions of the diagrams utilize same reference numbers, and a key 1405 is provided for reference. Referring to FIG. 14, a user 1410 (e.g., user device 190) accesses an application. The user 1410 may access additional information by logging in or creating an account. A welcome screen is illustrated, which leads to a dashboard (for example, as depicted in FIG. 5). From the dashboard, the user 1410 may navigate to a menu 1420 (for example as depicted in FIG. 3) or modify a position dashboard. The dashboard may include information regarding top players (e.g., top-three players) at a selected position, as well as information and/or comparison with selected players (e.g., players on a designated roster. Selecting the “my players” option may present an all players interface 1430. Each of the top players may be designated as a “Favorite” and added to the player listing 1430. If one player (e.g., player 3 1440) is selected, the application moves to application flow 1500 depicted in FIG. 15.

In FIG. 15, a specific player 1440 is selected (1510). Details of the selected player are output for display. The selected player may be “favorited” and added to the player listing 1430. From the player screen, user 1410 could navigate to a predictor interface (for example, on player screen 310 depicted in FIG. 7), a pre-game interface, an injury interface, and additional player statistical interface. In some cases, portions of the data provided on these interfaces may be incorporated into the player screen. For example, an interfaces can include an iterative slider for adjusting characteristics of the situation to explore potential ceilings and floors (e.g., a range of predictive performance) based on differing circumstances. In some cases, all detectable variables (e.g., weather, defense type, field type, injuries) can be adjusted using the iterative slider. The iterative slider can allow for real time adjustment of the predicted performance as conditions change. In some cases, the injury interface can be used to see how a player would be predicted to perform with one or more certain injuries (e.g., real, potential, or theoretical) both in the short term and in future games.

The predictor interface may provide average points per game, predictions for a next game, predicted points (e.g., as compared to actual points), and provide a current or upcoming season snapshot. Injury interface can provide details on current and past season injuries. The injuries may be displayed on a user interface with injury tags proximate injury locations on a body outline. Selecting a specific tag can cause additional injury detail to be provided, such as a description of the type of injury, cause of injury, severity of injury, and predicted or actual recovery.

Pre-game interface may provide a player performance score (PPS). The PPS can depict overall predicted player performance and can be based on factors of health, wellness, prior performance, situations (such as location of play, stadium, turf, weather). From the pregame interface, the application can display the top players at the selected player's position and/or provide a comparison between the selected player (1510) and another player. In some cases, the other player may be limited to a top player at the selected player's position, but this is merely an example. In some cases, as compared player may be selectable (e.g., via a drop-down menu limited to the selected player's position). User 1410 may then compare players 1520 (for example, as depicted in FIG. 8).

Referring back to FIG. 14, the menu 1420 provides additional primary screens for the application. Selecting the menu 1420 moves to application flow 1600 depicted in FIG. 16. The menu 1420 includes selections for my players 1430, player comparison, injury tracker, and exploration. In the compare screen the user 1410 navigate by position and select to players for comparison 1520 (for example, as depicted in FIG. 8).

The explore interface can enable general review of teams, players, or positions. The position can provide lists of players and a given position. Similarly, selecting team can provide lists of players at a selectable team. Meanwhile, selecting a player may provide a higher level overview than is provided in the selected player 1510 screen. From any of these interfaces, a player may be added to my players 1430 or selected 1510.

The injury tracker interface (for example, as depicted in FIG. 4A) can illustrate all injuries identified in a given season or week. The application could provide an interface of all players injured in a given timeframe (for example as depicted in FIG. 4D). The interface can enable filtering or sorting based on, for example, team affiliation, position, status, and predicted recovery. From this listing, specific players can be added to my players 1430 or selected 1510 for further comparison and/or investigation.

From the injury tracker interface (FIG. 4A) a specific injury tag can be selected. When selected, the application may provide additional descriptive information about the injury. If further selected (e.g., a “double-click”), the application may display an overview of players with the selected injury) e.g., as depicted in FIG. 4B). The interface can enable filtering or sorting based on, for example, team affiliation, position, status, and predicted recovery. From this listing, specific players can be added to my players 1430 or selected 1510 for further comparison and/or investigation.

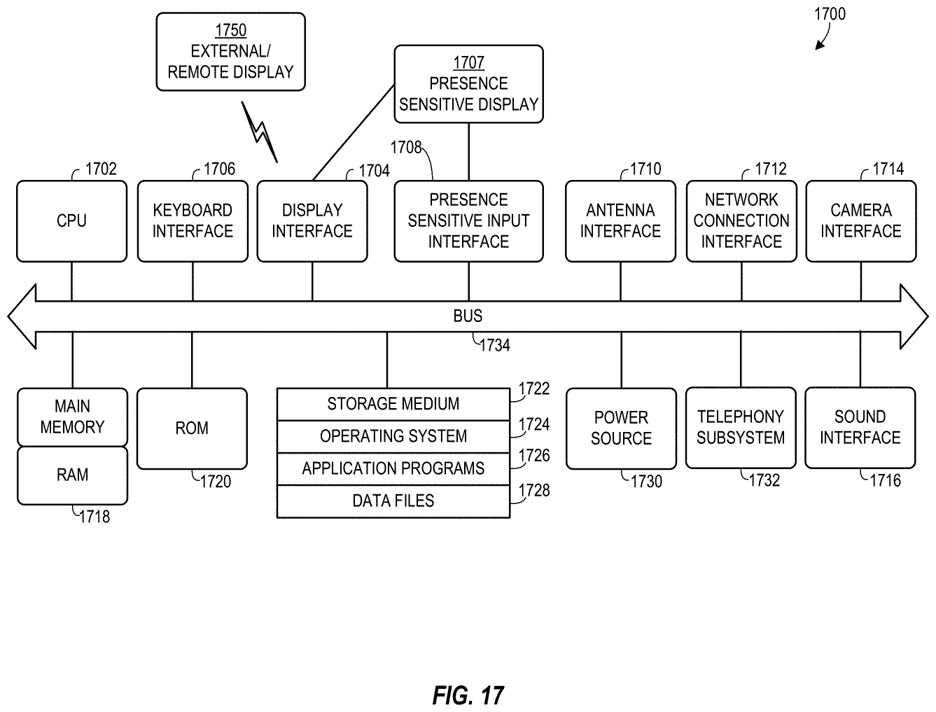

FIG. 17 is a block diagram of an illustrative computer system architecture 1700, according to an example implementation. As non-limiting examples, processors, microprocessors, and/or controllers of cameras 110, databases 120-140. System devices 150, and/or user devices 190 may be implemented using one or more elements from the computer system architecture 1700. It will be understood that the computing device architecture 1700 is provided for example purposes only and does not limit the scope of the various implementations of the present disclosed systems, methods, and computer-readable mediums.

The computing device architecture 1700 of FIG. 17 includes a central processing unit (CPU) 1702, where computer instructions are processed, and a display interface 1704 that acts as a communication interface and provides functions for rendering video, graphics, images, and texts on the display. In certain example implementations of the disclosed technology, the display interface 1704 may be directly connected to a local display, such as a touch-screen display associated with a mobile computing device. In another example implementation, the display interface 1704 may be configured for providing data, images, and other information for an external/remote display 1750 that is not necessarily physically connected to the mobile computing device. For example, a desktop monitor may be used for mirroring graphics and other information that is presented on a mobile computing device. In certain example implementations, the display interface 1704 may wirelessly communicate, for example, via a Wi-Fi channel or other available network connection interface 1712 to the external/remote display 1750.

In an example implementation, the network connection interface 1712 may be configured as a communication interface and may provide functions for rendering video, graphics, images, text, other information, or any combination thereof on the display. In one example, a communication interface may include a serial port, a parallel port, a general-purpose input and output (GPIO) port, a game port, a universal serial bus (USB), a micro-USB port, a high definition multimedia (HDMI) port, a video port, an audio port, a Bluetooth port, a near-field communication (NFC) port, another like communication interface, or any combination thereof. In one example, the display interface 1704 may be operatively coupled to a local display, such as a touch-screen display associated with a mobile device. In another example, the display interface 1704 may be configured to provide video, graphics, images, text, other information, or any combination thereof or an external/remote display 1750 that is not necessarily connected to the mobile computing device. In one example, a desktop monitor may be used for mirroring or extending graphical information that may be presented on a mobile device. In another example, the display interface 1704 may wirelessly communicate, for example, via the network connection interface 1712 such as a Wi-Fi transceiver to the external/remote display 1750.

The computing device architecture 1700 may include a keyboard interface 1706 that provides a communication interface to a keyboard. In one example implementation, the computing device architecture 1700 may include a presence-sensitive display interface 1708 for connecting to a presence-sensitive display 1707. According to certain example implementations of the disclosed technology, the presence-sensitive display interface 1708 may provide a communication interface to various devices such as a pointing device, a touch screen, a depth camera, etc. which may or may not be associated with a display.

The computing device architecture 1700 may be configured to use an input device via one or more of input/output interfaces (for example, the keyboard interface 1706, the display interface 1704, the presence sensitive display interface 1708, network connection interface 1712, camera interface 1714, sound interface 1716, etc.) to allow a user to capture information into the computing device architecture 1700. The input device may include a mouse, a trackball, a directional pad, a track pad, a touch-verified track pad, a presence-sensitive track pad, a presence-sensitive display, a scroll wheel, a digital camera, a digital video camera, a web camera, a microphone, a sensor, a smartcard, and the like. Additionally, the input device may be integrated with the computing device architecture 1700 or may be a separate device. For example, the input device may be an accelerometer, a magnetometer, a digital camera, a microphone, and an optical sensor.

Example implementations of the computing device architecture 1700 may include an antenna interface 1710 that provides a communication interface to an antenna; a network connection interface 1712 that provides a communication interface to a network. As mentioned above, the display interface 1704 may be in communication with the network connection interface 1712, for example, to provide information for display on a remote display that is not directly connected or attached to the system. In certain implementations, a camera interface 1714 is provided that acts as a communication interface and provides functions for capturing digital images from a camera. In certain implementations, a sound interface 1716 is provided as a communication interface for converting sound into electrical signals using a microphone and for converting electrical signals into sound using a speaker. According to example implementations, a random-access memory (RAM) 1718 is provided, where computer instructions and data may be stored in a volatile memory device for processing by the CPU 1702.

According to an example implementation, the computing device architecture 1700 includes a read-only memory (ROM) 1720 where invariant low-level system code or data for basic system functions such as basic input and output (I/O), startup, or reception of keystrokes from a keyboard are stored in a non-volatile memory device. According to an example implementation, the computing device architecture 1700 includes a storage medium 1722 or other suitable type of memory (e.g. such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files include an operating system 1724, application programs 1726 (including, for example, a web browser application, a widget or gadget engine, and or other applications, as necessary) and data files 1728 are stored. According to an example implementation, the computing device architecture 1700 includes a power source 1730 that provides an appropriate alternating current (AC) or direct current (DC) to power components.

According to an example implementation, the computing device architecture 1700 includes a telephony subsystem 1732 that allows the device 1700 to transmit and receive sound over a telephone network. The constituent devices and the CPU 1702 communicate with each other over a bus 1734.

According to an example implementation, the CPU 1702 has appropriate structure to be a computer processor. In one arrangement, the CPU 1702 may include more than one processing unit. The RAM 1718 interfaces with the computer bus 1734 to provide quick RAM storage to the CPU 1702 during the execution of software programs such as the operating system application programs, and device drivers. More specifically, the CPU 1702 loads computer-executable process steps from the storage medium 1722 or other media into a field of the RAM 1718 to execute software programs. Data may be stored in the RAM 1718, where the data may be accessed by the computer CPU 1702 during execution.

The storage medium 1722 itself may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer readable storage media allow a computing device to access computer-executable process steps, application programs and the like, stored on removable and non-removable memory media, to off-load data from the device or to upload data onto the device. A computer program product, such as one utilizing a communication system may be tangibly embodied in storage medium 1722, which may include a machine-readable storage medium.

According to one example implementation, the term computing device, as used herein, may be a CPU, or conceptualized as a CPU (for example, the CPU 1702 of FIG. 17). In this example implementation, the computing device (CPU) may be coupled, connected, and/or in communication with one or more peripheral devices, such as display. In another example implementation, the term computing device, as used herein, may refer to a mobile computing device such as a Smartphone, tablet computer, or smart watch. In this example implementation, the computing device may output content to its local display and/or speaker(s). In another example implementation, the computing device may output content to an external display device (e.g., over Wi-Fi) such as a TV or an external computing system.

In example implementations of the disclosed technology, a computing device may include any number of hardware and/or software applications that are executed to facilitate any of the operations. In example implementations, one or more I/O interfaces may facilitate communication between the computing device and one or more input/output devices. For example, a universal serial bus port, a serial port, a disk drive, a CD-ROM drive, and/or one or more user interface devices, such as a display, keyboard, keypad, mouse, control panel, touch screen display, microphone, etc., may facilitate user interaction with the computing device. The one or more I/O interfaces may be used to receive or collect data and/or user instructions from a wide variety of input devices. Received data may be processed by one or more computer processors as desired in various implementations of the disclosed technology and/or stored in one or more memory devices. One or more network interfaces may facilitate connection of the computing device inputs and outputs to one or more suitable networks and/or connections; for example, the connections that facilitate communication with any number of sensors associated with the system. The one or more network interfaces may further facilitate connection to one or more suitable networks; for example, a local area network, a wide area network, the Internet, a cellular network, a radio frequency network, a Bluetooth enabled network, a Wi-Fi enabled network, a satellite-based network any wired network, any wireless network, etc., for communication with external devices and/or systems.

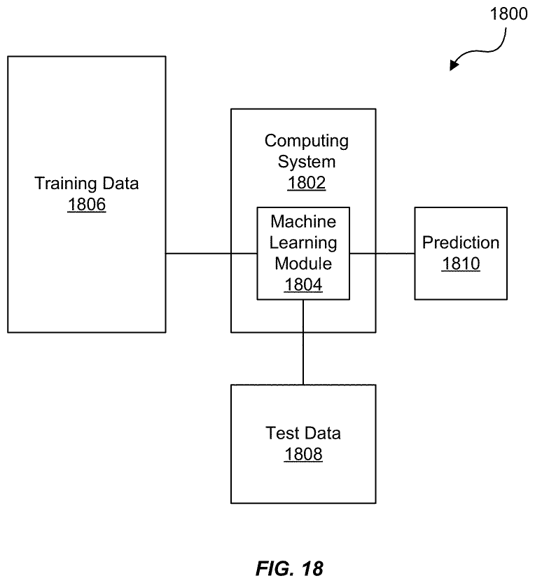

While the various embodiments disclosed herein may be implemented using generally any of a variety of machine learning models (e.g., with machine learning module 1804), a computing system 1802 is operable to implement a Mixed Effect Random Forest (MERF) model in one exemplary embodiment as illustrated in FIG. 18. ME RT models may be advantageously employed when non-negligible random effects exist, such as relatively large idiosyncrasies and clustered data.

For example, much of the data pertaining to players in the National Football League (NFL) exist as clustered data. This clustered data has a number of longitudinal clusters, where multiple measurements may be obtained on a per player basis to model certain phenomena.

In particular, Fantasy Football points may be modeled as a function of various player injuries, player performances, and other miscellaneous factors, with multiple measurements for each player, One challenge regards accounting for different idiosyncrasies caused by disconnected factors.

The MERF model advantageously processes such clustered data. In such a model, each cluster is assigned a random effect that is learned but drawn from a prior that is itself learned from the data. The MERE model is operable to combine linear mixed effects models with the power of non-parametric modelling, assuming a generative model of the form:

y=ƒ(X)+bᵢA+e, where y is a target variable, X regards fixed effect features, Z regards random effect features, i is a cluster index, and bᵢ is the random effect coefficients. X is assumed to be p dimensional (e.g., there are p features), and Z is assumed to be q dimensional (e.g., there are q features).

Generally, it is assumed that there are k clusters during training of the MERF model and that there are differences between data clusters i. But, these differences are assumed to be drawn from the same distribution. Thus, the non-linear function ƒ (may be learned using a random forest. More generally, ƒ(X) can be any non-linear regression model like gradient boosting trees or a deep neural network.

An expectation-maximization (EM) technique may be used to fit the MERF model. The EM algorithm is generally an alternative optimization. For example, one parameter may be iteratively optimized while keeping the others fixed until convergence. A generalized log likelihood (GLL), which can be computed at every iteration, may be representative of a measure of training loss. As the GLL decreases, the fit of the MERF model improves. Once it “flattens out”, the computing system may stop iterating as the fit of the MERF model has converged to a solution.

Once fit, the MERF model can be used to predict player performance. And, for data in “known” clusters that the MERF model was trained with, the prediction 1810 includes the random effect correction. For data in “new” clusters that the MERF model was not trained with, the prediction includes the fixed effect.

The computing system 1802 may be operable to handle variances in different clusters by modeling them separately. In this embodiment, each NFL player is used to train the MERF model according to position (e.g., quarterback, running back, offensive lineman, linebacker, safety, etc.). And, sample sets of data that apply to each position are input as part of the training process of the MERF model. For example, the training data 1806 may comprise data from every NFL player over the course of some predetermined period of time (e.g., five years), as illustrated in the following table, TABLE 1:

TABLE 1

| name | name_id | team | season | week | bye_week | injury_list1 | ko_time | weather_ko | temp_ko |
|---|---|---|---|---|---|---|---|---|---|
| A. J. Brown | A. J. Brown | TEN | 2019 | 1 | 11 | 0 | 1300 | 3 | 69 |
| | WR | | | | | | | | |
| A. J. Brown | A. J. Brown | TEN | 2019 | 2 | 11 | 0 | 1300 | 1 | 92 |
| | WR | | | | | | | | |
| A. J. Brown | A. J. Brown | TEN | 2019 | 3 | 11 | 0 | 2020 | 3 | 73 |
| | WR | | | | | | | | |
| . . . | | | | | | | | | |
| Deon Yelder | Deon Yelder | KC | 2020 | 9 | 0 | 0 | 0 | 2 | 68 |
| | TE | | | | | | | | |
| Nick Keizer | Nick Keizer | KC | 2020 | 9 | 0 | 0 | 0 | 2 | 68 |
| | TE | | | | | | | | |
| Travis Kelce | Travis Kelce | KC | 2020 | 9 | 0 | 0 | 0 | 2 | 68 |
| | TE | | | | | | | | |

| name | surface_group | grass | rain | snow | humid | . . . | Abdominal | Achilles | Ankle |
|---|---|---|---|---|---|---|---|---|---|
| A. J. Brown | Grass | 1 | 0 | 0 | 0 | . . . | 0 | 0 | 0 |
| A. J. Brown | Grass | 1 | 0 | 0 | 1 | . . . | 0 | 0 | 0 |
| A. J. Brown | Grass | 1 | 0 | 0 | 0 | . . . | 0 | 0 | 0 |
| . . . | | | | | | . . . | | | |
| Deon Yelder | 0 | 1 | 0 | 0 | 0 | . . . | 0 | 0 | 0 |
| Nick Keizer | 0 | 1 | 0 | 0 | 0 | . . . | 0 | 0 | 0 |
| Travis Kelce | 0 | 1 | 0 | 0 | 0 | . . . | 0 | 0 | 0 |

TABLE 1 shows every player in their various statistics over the course of the predetermined period of time. This per player data may include the player's position, individual weeks (e.g., games) the player may have played in, weather of various games the player may have played in, game surfaces that the player may have played on, game time temperatures of the games player played in, various types of injuries the player may have suffered during a game, etc. Then, this per player data may be input to the MERF model on a position by position basis. For example, all the data pertaining to wide receivers may be input to train the MERF model to predict how a particular wide receiver will perform in a given week in the NFL.

Now, with the MERF model trained with wide receivers, a certain wide receiver may be selected as test data 1808 for the trained model. For example, the wide receiver A. J. Brown may have suffered a particular injury in the previous week and will be playing on grass in the coming week with a weather prediction of sunny and 75°. There course many other statistics pertaining to the wide receiver A. J. Brown. But, that data may be input to the trained MERF model to predict what that wide receivers performance will be in the next game (e.g., based on all wide receivers, their past game time conditions, their past injuries, etc.).

To illustrate with pseudocoele, the training data for the wide receiver position may have the following features (i.e., the above mentioned X vector): co_bye (bye week); grass (field type); rain (weather condition); snow (weather condition); humid (weather condition); stadium_type (stadium type); lag_out (held type); Hamstririg (injury type); Concussion (injury type); Groin (injury type); Back (injury type); Hip (injury type); Illness (injury type); Foot (injury type); Ankle Sprain (injury type); Calf (injury type); Toe (injury type); Rib Chest (injury type); High Ankle Sprain (injury type); ACJoint (injury type); Abdominal (injury type); MCL (injury type); Quest (field type); def_list (field type); recepyardrank (reception yards rank); and rushrank (rushing yards rank).

Then y is the vector containing a single target variable, actualFPPGPoints. And, z is the vector containing two variables for modelling a random mean for each cluster, such as the season and week. The clusters are the vectors that include the player ID for each sample. Now, given the X, y, clusters, and Z matrices, the data can be fitted to the MERF model by instantiations of the MERF model. The MERF model may have two hyperparameters:

n_estimators (e.g., the number of trees used to train the random forest). As a default, 500 may be used.

max_iterations (e.g., the maximum number of iterations to run for the EM model). Generally, this may be set to 30 for each position to achieve GLL.

Once fit, the MERF model may be used to predict on test data samples given X Z, and clusters. The predict code handles whether or not to apply the random effect correction based on whether the cluster id of the new sample was seen in training or not. Thus, for the wide receiver position:

```
  def processWR(df, df1, currWeek):
    wr=df.loc[df[‘position’].isin(pos_wr)]
    xwr=wr[[‘co_bye’,‘grass’,‘rain’,‘snow’, ‘humid’,
    ‘stadium_type’,‘lag_out’,
    ‘Hamstring’, ‘Concussion’, ‘Groin’ , ‘Back’, ‘Hip’, ‘Illness’ , ‘Foot’,
‘Ankle Sprain’, ‘Calf’,
    ‘Toe’, ‘Rib Chest’, ‘High Ankle Sprain’ , ‘AC Joint’, ‘Abdominal’,
‘MCL’, ‘quest’, ‘def_list’,
    ‘recep_yard_rank’,‘rush_rank’]]
    ywr=wr[‘actualFPPGPoints’]
    zwr=wr[[‘season’,‘week’]]
    cwr=wr[‘pid’]
    merf_wr=MERF(max_iterations=30)
    merf_wr.fit(xwr, zwr, cwr,ywr)
    wr1 = df1.loc[df1[‘position’].isin(pos_wr)]
    xwr1 = wr1[[‘co_bye’, ‘grass’, ‘rain’, ‘snow’, ‘humid’,
    ‘stadium_type’, ‘lag_out’,
      ‘Hamstring’, ‘Concussion’, ‘Groin’, ‘Back’, ‘Hip’, ‘Illness’,
‘Foot’, ‘Ankle Sprain’, ‘Calf’,
      ‘Toe’, ‘Rib Chest’, ‘High Ankle Sprain’, ‘AC Joint’, ‘Abdominal’,
‘MCL’, ‘quest’, ‘def_list’,
      ‘recep_yard_rank’, ‘rush_rank’]]
    xwr1 = xwr1.round(3)
    zwr1 = wr1[[‘season’, ‘week’]]
    cwr1 = wr1[‘pid’]
    predsFFP =merf_wr.predict(xwr1, zwr1, cwr1)
    wr1[‘pred_points’] = np.clip(predsFFP, a_min = 0, a_max=50)
    wr1[‘predictedFPPGPoints’] = wr1[‘pred_points’]
      wr1.to_csv(F“data/predictions/Week{currWeek}/wr_post10.csv”)
    return wr1 (i.e., the prediction of a particular wide receiver).
```

While shown and described with respect to a particular position (e.g., wide receiver) in one particular sport (e.g., the NFL), the embodiments herein may be used in a variety of sports to predict individual performances of players in their respective sports. For example, the embodiments herein may be operable to predict the performance of a striker on a soccer team, a pitcher on a baseball team, a power forward on a basketball team, etc. And, the embodiments herein are not intended to be limited to any particular aspects of players in these sports. For example, swimmers in indoor swimming pools may not require statistics pertaining to weather. Accordingly, when training the machine learning module 1804 with swimmers, information pertaining to the weather may not be processed through the machine learning module 1804.

Moreover, clusters of data may be even further refined. For example, the machine learning module 1804 may be trained on data pertaining to running backs to predict the performance of a running back in an upcoming NFL game. However, not all running backs are equal in terms of size, strength, and/or agility. That is, Darren Sproles is not the same running back in terms of size and strength as Derrick Henry. Accordingly, if it were desired to predict the performance of a particular running back, the machine learning module 1804 may be trained with data pertaining to running backs of comparable size, strength, and/or agility.

The embodiments herein may be combined and/or rearranged with any of the embodiments disclosed herein. Some embodiments are now disclosed by way of example only and not intended to limit the scope of the disclosure herein.

One or more embodiments of the present disclosure may be implemented according to at least the following:

Clause 1: A system comprising: a storage; and a processor configured to: receive impairment data, transform the impairment data into system process data, receive a query from a remote device, and analyze the system process data to determine predictive performance.

Clause 2: The system of clause 1, wherein the processor is further configured to: biostatistically analyze the system process data based on the query to identify a subset of relevant data from the system process data; and analyze the identified subset of relevant system process data to determine predictive performance.

Clause 3: The system of clause 1 or clause 2, wherein the processor is configured to process the system process data utilizing a trained machine-learning algorithm.

Clause 4: The system of any of clauses 1-3, wherein the impairment data comprises video images; and the processor is further configured to transform the impairment data comprises generating a stick figure overlay of the video images.

Clause 5: The system of clause 4, wherein the processor is further configured to analyze the stick figure overlay to determine injury impact force and angle.

Clause 6: The system of any of clauses 1-5, wherein the impairment data comprises social media data; and the processor is further configured to perform natural language processing on the social media data to transform the social media data into injury-specific information.

Clause 7: The system of clause 6, wherein the processor is further configured to access social media sites associated with players and scrape the social media data from the social media sites.

Clause 8: The system of clause 6 or clause 7, wherein the processor is further configured to automatically identify social media sites associated with players to extract the social media data.

Clause 9: The system of clause 8, wherein the processor is configured to automatically identify the social media sites based on crawling of official team websites.

Clause 10: The system of clause 8 or clause 9, wherein the processor is configured to automatically identify the social media sites by analyzing social media data associated with accounts corresponding to player names to distinguish between like-named accounts.

Clause 11: The system of any of clauses 1-10, wherein the processor is configured to generate an impairment graphical interface and output the impairment graphical interface for display.

Clause 12: The system of clause 11, wherein the impairment graphical interface comprises: a representation of a body; and impairment icons located on the representation in locations proximate impairment locations.

Clause 13: The system of any of clauses 1-12, wherein the processor is configured to generate a player interface comprising predicted performance and a range of the predicted performance.

Clause 14: The system of clause 13, wherein the player interface further comprises adjustable sliders configured to modify system assumptions, and the processor is configured to update the predicted performance and the range of the predicted performance based on user adjustments to the adjustable sliders.

Clause 15: The system of any of clauses 1-14, wherein the processor is further configured to cluster system process data into a plurality of clusters and analyze the system process data based on the clusters.

Clause 16: The system of any of clauses 1-15, wherein the processor is further configured to: determine the predictive performance of a particular player falls below a threshold; access a player roster; and automatically replace the particular player on the player roster.

Clause 17: The system of clause 16, wherein the threshold is based on highest alternative predictive value of alternative players.

Clause 18: The system of clause 16 or clause 17, wherein replacing the particular player comprises removing the particular player from the player roster.

Clause 19: The system of clause 16 or clause 17, wherein replacing the particular player comprises removing the particular player from a starting lineup of the player roster.

Clause 20: The system of any of clauses 16-19, wherein the particular player is replaced with an available player having a highest predicted performance.

Clause 21: A method comprising: receiving impairment data, transforming the impairment data into system process data, receiving a query from a remote device, and analyzing the system process data to determine predictive performance.

Clause 22: The method of clause 21 further comprising biostatistically analyzing the system process data based on the query to identify a subset of relevant data from the system process data; and analyzing the identified subset of relevant system process data to determine predictive performance.

Clause 23: The method of clause 21 or clause 22 comprising processing the system process data utilizing a trained machine-learning algorithm.

Clause 24: The method of any of clauses 21-23, wherein the impairment data comprises video images, and the method further comprises transforming the impairment data comprises generating a stick figure overlay of the video images.

Clause 25: The method of clause 24 further comprising analyzing the stick figure overlay to determine injury impact force and angle.

Clause 26: The method of any of clauses 21-25, wherein the impairment data comprises social media data, and the method further comprising performing natural language processing on the social media data to transform the social media data into injury-specific information.

Clause 27: The method of clause 26 further comprising accessing social media sites associated with players and scrape the social media data from the social media sites.

Clause 28: The method of clause 26 or clause 27 further comprising to automatically identifying social media sites associated with players to extract the social media data.

Clause 29: The method of clause 28 comprising automatically identifying the social media sites based on crawling of official team websites.

Clause 30: The method of clause 28 or clause 29 comprising automatically identifying the social media sites by analyzing social media data associated with accounts corresponding to player names to distinguish between like-named accounts.

Clause 31: The method of any of clauses 21-30 further comprising generating an impairment graphical interface and output the impairment graphical interface for display.

Clause 32: The method of clause 31, wherein the impairment graphical interface comprises: a representation of a body; and impairment icons located on the representation in locations proximate impairment locations.

Clause 43: The method of any of clauses 31-42 further comprising generating a player interface comprising predicted performance and a range of the predicted performance.

Clause 34: The method of clause 33, wherein the player interface further comprises adjustable sliders configured to modify system assumptions, and the method further comprises updating the predicted performance and the range of the predicted performance based on user adjustments to the adjustable sliders.

Clause 35: The method of any of clauses 21-34 further comprising clustering system process data into a plurality of clusters and analyze the system process data based on the clusters.

Clause 36: The method of any of clauses 21-35 further comprising determining the predictive performance of a particular player falls below a threshold; accessing a player roster; and automatically replacing the particular player on the player roster.

Clause 37: The method of clause 36, wherein the threshold is based on highest alternative predictive value of alternative players.

Clause 38: The method of clause 36 or clause 37, wherein replacing the particular player comprises removing the particular player from the player roster.

Clause 39: The method of clause 36 or clause 37, wherein replacing the particular player comprises removing the particular player from a starting lineup of the player roster.

Clause 40: The method of any of clauses 36-39, wherein the particular player is replaced with an available player having a highest predicted performance.

Clause 41: A non-transitory computer readable medium having stored thereon instructions to control one or more processors to execute the method of any of Clauses 21-40.

As used in this application, the terms “component,” “module,” “system,” “server,” “processor,” “memory,” and the like are intended to include one or more computer-related units, such as but not limited to hardware, firmware, a combination of hardware and software, software, or software in execution. For example, a component may be, but is not limited to being, a process running on a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Certain embodiments and implementations of the disclosed technology are described above with reference to block and flow diagrams of systems and methods and/or computer program products according to example embodiments or implementations of the disclosed technology. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, may be repeated, or may not necessarily need to be performed at all, according to some embodiments or implementations of the disclosed technology.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable memory that can direct a computer or other programmable data processing apparatus to function in a particular manner, such that the instructions stored in the computer-readable memory produce an article of manufacture including instruction means that implement one or more functions specified in the flow diagram block or blocks.

As an example, embodiments or implementations of the disclosed technology may provide for a computer program product, including a computer-usable medium having a computer-readable program code or program instructions embodied therein, said computer-readable program code adapted to be executed to implement one or more functions specified in the flow diagram block or blocks. Likewise, the computer program instructions may be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions, and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special-purpose hardware and computer instructions.

In this description, numerous specific details have been set forth. It is to be understood, however, that implementations of the disclosed technology may be practiced without these specific details. In other instances, well-known methods, structures and techniques have not been shown in detail in order not to obscure an understanding of this description. References to “one embodiment,” “an embodiment,” “some embodiments,” “example embodiment,” “various embodiments,” “one implementation,” “an implementation,” “example implementation,” “various implementations,” “some implementations,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form. By “comprising” or “containing” or “including” is meant that at least the named element, or method step is present in article or method, but does not exclude the presence of other elements or method steps, even if the other such elements or method steps have the same function as what is named.

As used herein, unless otherwise specified the use of the ordinal adjectives “first,” “second,” “third,” etc., to describe a common object, merely indicate that different instances of like objects are being referred to, and are not intended to imply that the objects so described must be in a given sequence, either temporally, spatially, in ranking, or in any other manner.

While certain embodiments of this disclosure have been described in connection with what is presently considered to be the most practical and various embodiments, it is to be understood that this disclosure is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

This written description uses examples to disclose certain embodiments of the technology and also to enable any person skilled in the art to practice certain embodiments of this technology, including making and using any apparatuses or systems and performing any incorporated methods. The patentable scope of certain embodiments of the technology is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system, comprising:
a storage; and
a processor configured to:
receive impairment data, transform the impairment data into system process data,
receive a query from a remote device, and analyze the system process data to determine predictive performance.

2. The system of claim 1, wherein:
the processor is further configured to:
biostatistically analyze the system process data based on the query to identify a subset of relevant data from the system process data; and
analyze the identified subset of relevant system process data to determine predictive performance.

3. The system of claim 1, wherein:
the processor is configured to process the system process data utilizing a trained machine-learning algorithm.

4. The system of claim 1, wherein:
the impairment data comprises video images; and
the processor is further configured to transform the impairment data comprises generating a stick figure overlay of the video images.

5. The system of claim 4, wherein:
the processor is further configured to analyze the stick figure overlay to determine injury impact force and angle.

6. The system of claim 1, wherein:
the impairment data comprises social media data; and
the processor is further configured to perform natural language processing on the social media data to transform the social media data into injury-specific information.

7. The system of claim 6, wherein:
the processor is further configured to access social media sites associated with players and scrape the social media data from the social media sites.

8. The system of claim 6, wherein:
the processor is further configured to automatically identify social media sites associated with players to extract the social media data.

9. The system of claim 8, wherein:
the processor is configured to automatically identify the social media sites based on crawling of official team websites.

10. The system of claim 8, wherein:
the processor is configured to automatically identify the social media sites by analyzing social media data associated with accounts corresponding to player names to distinguish between like-named accounts.

11. The system of claim 1, wherein:
the processor is configured to generate an impairment graphical interface and output the impairment graphical interface for display.

12. The system of claim 11, wherein:
the impairment graphical interface comprises:
a representation of a body; and
impairment icons located on the representation in locations proximate impairment locations.

13. The system of claim 1, wherein:
the processor is configured to generate a player interface comprising predicted performance and a range of the predicted performance.

14. The system of claim 13, wherein:
the player interface further comprises adjustable sliders configured to modify system assumptions, and
the processor is configured to update the predicted performance and the range of the predicted performance based on user adjustments to the adjustable sliders.

15. The system of claim 1, wherein:
the processor is further configured to cluster system process data into a plurality of clusters and analyze the system process data based on the clusters.

16. The system of claim 1, wherein:
the processor is further configured to:
determine the predictive performance of a particular player falls below a threshold;
access a player roster; and
automatically replace the particular player on the player roster.

18. The system of claim 16, wherein:
the threshold is based on highest alternative predictive value of alternative players.

19. The system of claim 16, wherein:
replacing the particular player comprises removing the particular player from the player roster.

20. The system of claim 16, wherein:
replacing the particular player comprises removing the particular player from a starting lineup of the player roster.

21. The system of claim 16, wherein:
the particular player is replaced with an available player having a highest predicted performance.
